(19) United States
(12) Patent Application Publication
(10) Pub. No.: US 2009/0173192 A1
(43) Pub. Date: Jul. 9, 2009

(54) ANTI-LOOSE AND ANTI-DETACHMENT INSULATED SCREWDRIVER

(76) Inventor: CHIH-CHING HSIEH, Feng Yuan (TW)

Correspondence Address: Guice Patents PLLC, 12647 Galveston Court #302, Manassas, VA, 20112, US

(21) Appl. No.: 12/408,742

(22) Filed: Mar. 23, 2009

Related U.S. Application Data
(63) Continuation-in-part of application No. 11/863,242, filed on Sep. 27, 2007.

(51) Int. Cl. B25B 15/00; B25B 23/16

(52) U.S. Cl. 81/436; 81/177.1

(57) ABSTRACT

An anti-loose and anti-detachment insulated screwdriver including a main body made of insulation material, a shank body enclosed in the main body and a driving member having a top end as a driving end. A bottom end of the driving member is connected with a top end of the shank body. The main body has a handle section and a stem section. A top end of the stem section of the main body encloses a circumference of the driving member with the driving end of the driving member exposed to outer side of the main body. The main body is connected with the shank body by greater connection strength so that the shank body can bear greater twisting force. The shank body has such a configuration that the total weight of the insulated screwdriver is reduced.

This is a continuation in part application of applicant's U.S. patent application Ser. No. 11/863,242, filed Sep. 27, 2007.

### FIELD OF THE INVENTION

The present invention is related to a hand tool, and more particularly to an insulated screwdriver, in which the metal-made shank body is prevented from loosening from the main body made of insulation material.

### BACKGROUND OF THE INVENTION

FIG. 1 shows a conventional insulated screwdriver 10 including a main body 12 made of insulation material and a screwdriver shank 17 having a driving section 18 at a front end of the shank 17. The main body 12 has a handle section 14 and a sleeve section 16. The screwdriver shank 17 is disposed in the main body 12 and enclosed by the main body 12 with the driving section 18 protruding from the sleeve section 16 for driving a threaded member. Accordingly, the exposed area of the metal-made screwdriver shank 17 can be minimized to reduce the possibility of electric shock.

Please now refer to FIG. 2. The conventional screwdriver shank 17 is a cylindrical rod so that the screwdriver shank 17 is connected with the main body 12 by poor strength. After a period of use or when bearing an excessively great force, the screwdriver shank 17 is likely to loosen or even detach from he main body 12. Once the screwdriver shank is loosened or detached from the main body, it becomes impossible to further use the insulated screwdriver.

In order to enhance the connection strength between the screwdriver shank and the main body, the screwdriver shank 17 is often made with a considerable length, whereby a bottom end of the screwdriver shank extends deep to a bottom end of the handle section 14 as shown in FIG. 1. However, this only gives little improvement and leads to increment of weight of the insulated screwdriver 10.

FIG. 3 shows another type of conventional insulated screwdriver 20 having a hexagonal screwdriver shank 25 for increasing connection strength between the screwdriver shank and the main body 22.

The connection strength between the screwdriver shank 25 and the main body 22 of the insulated screwdriver of FIG. 3 is better than that of the insulated screwdriver of FIG. 1. However, the connection strength between the screwdriver shank and the main body is still insufficient. This is because the angle contained between two adjacent faces 23, 24 of the screwdriver shank 25 is quite small so that only a little stopping force is provided. When bearing a greater force, the screwdriver shank is still likely to loosen or even detach from he main body.

Moreover, the weight of the hexagonal screwdriver shank is approximately equal to that of the cylindrical screwdriver shank. Therefore, the insulated screwdriver of FIG. 3 still has a considerable weight.

U.S. patent application Ser. No. 11/863,242 of this applicant, entitled “handle tool”, discloses an improved screwdriver to overcome the above problems.

### SUMMARY OF THE INVENTION

It is therefore a primary object of the present invention to provide an insulated screwdriver, in which the connection strength between the shank body and the main body, which are made of different materials, is enhanced.

It is a further object of the present invention to provide the above insulated screwdriver, in which the weight of the insulated screwdriver is reduced.

The insulated screwdriver of the present invention includes a main body made of insulation material, having a handle section and a stem section connected with a top end of the handle section; a shank body enclosed in the main body, and a driving member having a top end as a driving end. A bottom end of the driving member is connected with a top end of the shank body; a top end of the stem section of the main body encloses a circumference of the driving member with the driving end of the driving member exposed to outer side of the main body.

According to the configuration of the shank body, the connection strength between the shank body and the main body is enhanced, and the weight of the insulated screwdriver is reduced.

The present invention can be best understood through the following description and accompanying drawings wherein:

### BRIEF DESCRIPTION OF THE DRAWINGS

FIG. 1 is a longitudinally sectional view of a conventional insulated screwdriver;

FIG. 2 is a cross-sectional view taken along line 2-2 of FIG. 1;

FIG. 3 is a cross-sectional view of another type of conventional insulated screwdriver;

FIG. 4 is a perspective view of a first embodiment of the present invention;

FIG. 5 is a longitudinally sectional view according to FIG. 4;

FIG. 6 is a cross-sectional view of the shank body of the first embodiment of the present invention;

FIG. 7 is a sectional view taken along line 7-7 of FIG. 5;

FIG. 8 is a sectional view taken along line 8-8 of FIG. 5;

FIG. 9 is a perspective view of a second embodiment of the present invention;

FIG. 10 is a partially longitudinally sectional view according to FIG. 9;

FIG. 11 is a longitudinally sectional view of a third embodiment of the present invention;

FIG. 12 is a cross-sectional view of the shank body of the third embodiment of the present invention;

FIG. 13 is a sectional view taken along line 13-13 of FIG. 11; and

FIG. 14 is a sectional view taken along line 14-14 of FIG. 11.

### DETAILED DESCRIPTION OF THE PREFERRED EMBODIMENTS

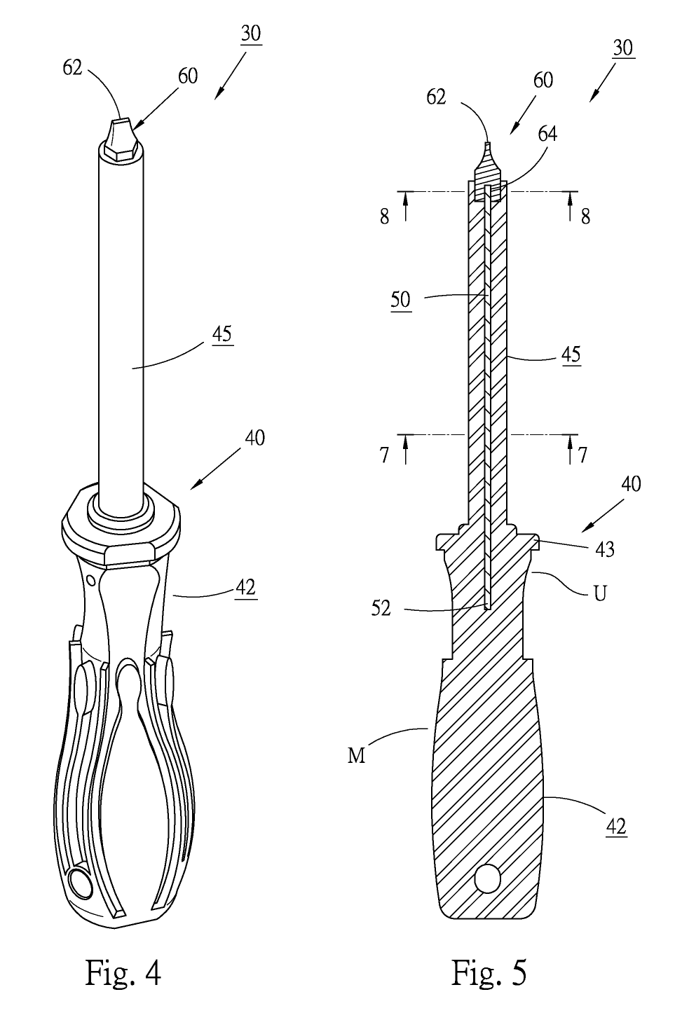

Please refer to FIGS. 4 and 5. According to a first embodiment, the insulated screwdriver 30 of the present invention includes a main body 40, a shank body 50 and a driving member 60.

The main body 40 is made of insulation material, such as PP, ABS or any other suitable plastic material, or plastic steel. The main body 40 has a handle section 42 and a stem section 45 upward extending from a top end 43 of the handle section 42 along an axis thereof. Raised/recessed stripes are formed on a surface of the handle section 42 for increasing frictional force to facilitate gripping.

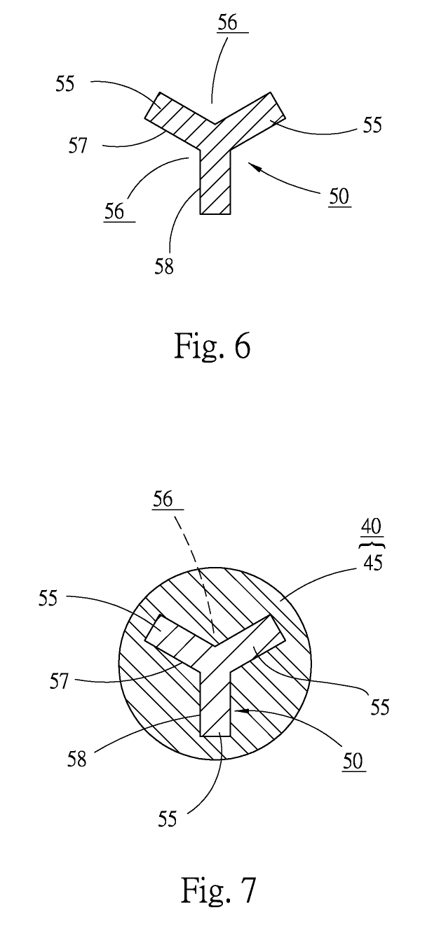

Referring to FIG. 6, the shank body 50 is made of metal material and has three rib sections 55. Accordingly, the shank body 50 has a unified Y-shaped or T-shaped cross-section. Each two adjacent rib sections 55 define therebetween a recessed space 56. The shank body 50 is embedded in the main body 40. In this embodiment, a bottom end of the shank body 50 is simply positioned in an upper portion U of the handle section 42 without deep extending to a middle portion M or a lower portion of the handle section 42. To speak more specifically, the bottom end 52 of the shank body 50 is positioned between a top end 43 and the middle portion M of the handle section 42.

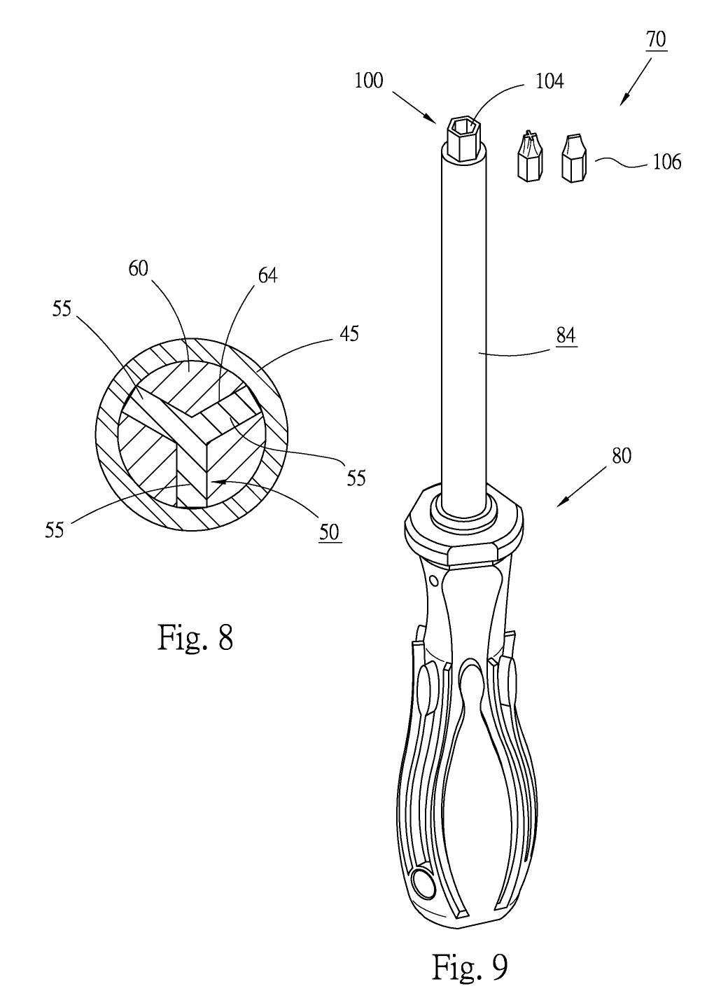

The driving member 60 can have a polygonal outer circumference, for example, a hexagonal outer circumference. The driving member 60 has a top end as a driving end 62 in the form of a slotted screwdriver bit, a Phillips screwdriver bit or the like for driving a threaded member. A socket 64 is formed on a bottom end of the driving member 60 as shown in FIG. 5. The socket 64 is Y-shaped or T-shaped as shown in FIG. 8 complementarily to the shape of the shank body 50. The top end of the shank body 50 can be inserted into the socket 64 of the driving member 60. The top end of the stem section 45 of the main body 40 encloses the circumference of the driving member 60 with the driving end 62 exposed to outer side as shown in FIGS. 4 and 5.

In practice, the screwdriver shank 50 and the driving member 60 are enclosed in the main body 40 by means of injection molding.

The embodiment of the insulated screwdriver of the present invention is used in the same manner as an ordinary screwdriver. The driving end 62 of the driving member 60 can be plugged into a threaded member. When the handle section 42 is twisted, the shank body 50 is driven by the main body 40 to in turn drive the driving member 60 for driving the threaded member. According to the above arrangement, only the driving end 62 of the driving member 60 of the screwdriver 30 is exposed to outer side of the main body. Therefore, a user who holds the screwdriver 30 with a hand is protected from electric shock.

Referring to FIG. 7, as aforesaid, the shank body 50 is embedded and enclosed in the main body 40. Under such circumstance, the materials of the handle section 42 and the stem section 45 are inlaid and engaged in the spaces 56 and the adjacent wall faces 57, 58 of the shank body 50 provide larger stopping force for the handle section 42 and the stem section 45. Therefore, the main body 40 is connected with the shank body 50 by greater connection strength so that the shank body 50 can bear greater twisting force.

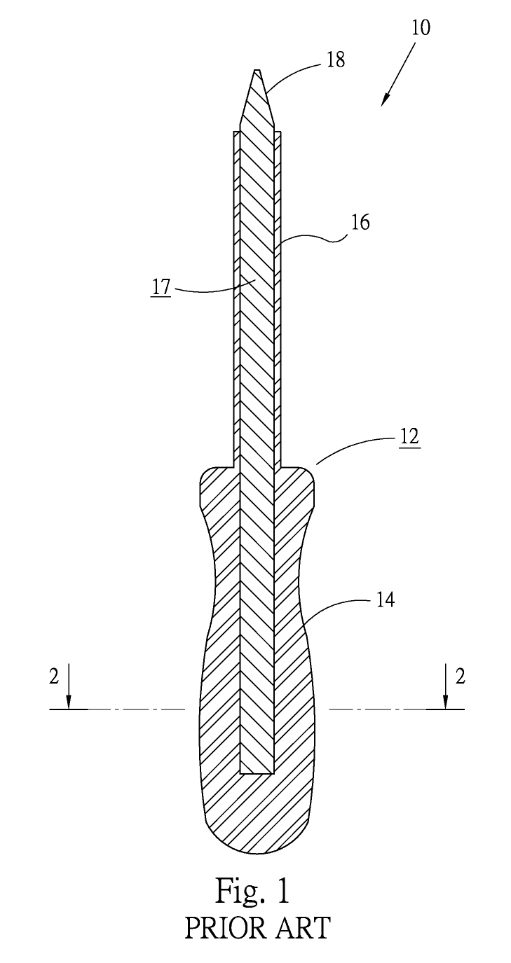

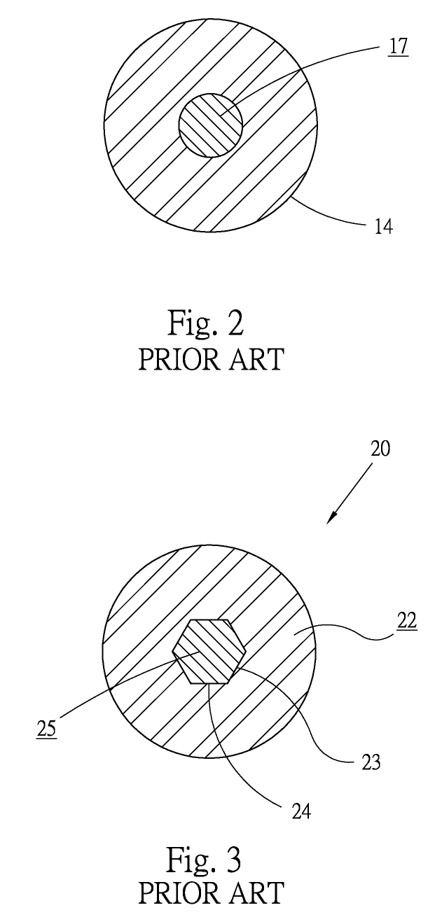

Moreover, the shank body 50 is formed with the rib sections 55 instead of the cylindrical or hexagonal configuration of the conventional screwdriver shank. Therefore, the volume of the shank body 50 is much smaller than that of the conventional screwdriver shank and the shank body 50 is much lighter than the cylindrical or hexagonal screwdriver shank of the conventional insulated screwdriver. In addition, the shank body 50 provides greater stopping force for the main body 40 so that the bottom end 52 of the shank body 50 only needs to be positioned in the upper portion U of the handle section 42 for sufficiently bearing the twisting force. Accordingly, the shank body 50 can be made with shorter length so as to reduce the weight of the insulated screwdriver 30. The insulated screwdriver 30 of the present invention is about 25% lighter than the conventional insulated screwdriver of FIG. 1.

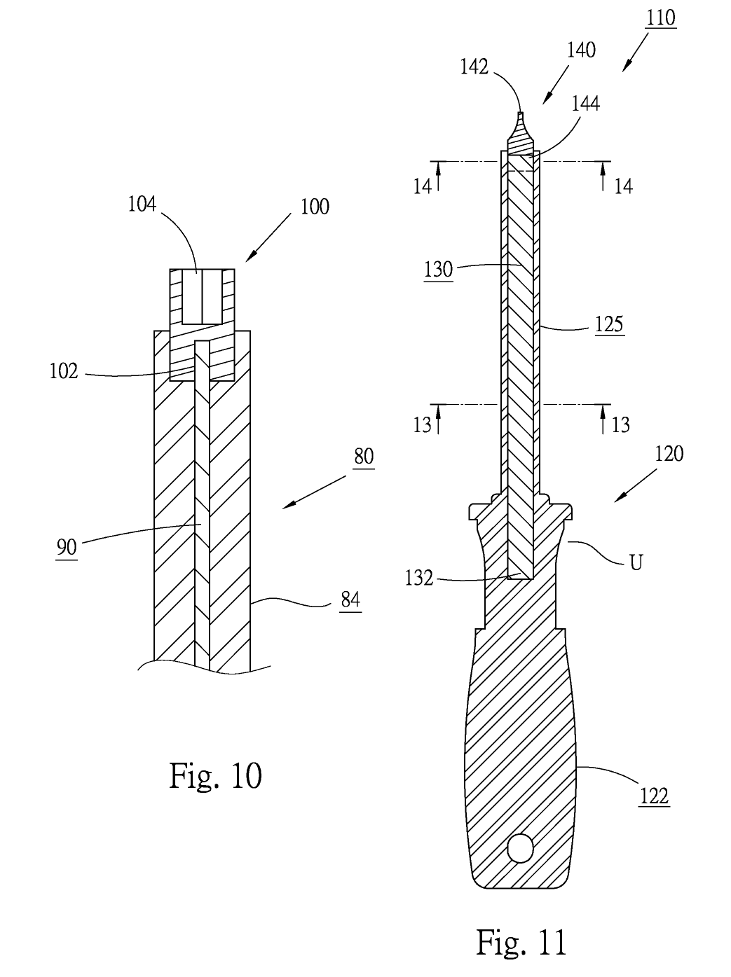

FIGS. 9 and 10 show a second embodiment of the insulated screwdriver 70 of the present invention, which also includes a main body 80, a shank body 90 and a driving member 100. The second embodiment is substantially identical to the first embodiment in structure. Only the structure of the driving member 100 of the second member is different from that of the first embodiment. The top end of the shank body 90 is inserted in the socket 102 of the bottom end of the driving member 100. The stem section 84 of the main body 80 encloses the outer circumference of the driving member 100. The driving end 104 of the driving member 100 is a hexagonal insertion hole for installing different configurations of bits 106 therein.

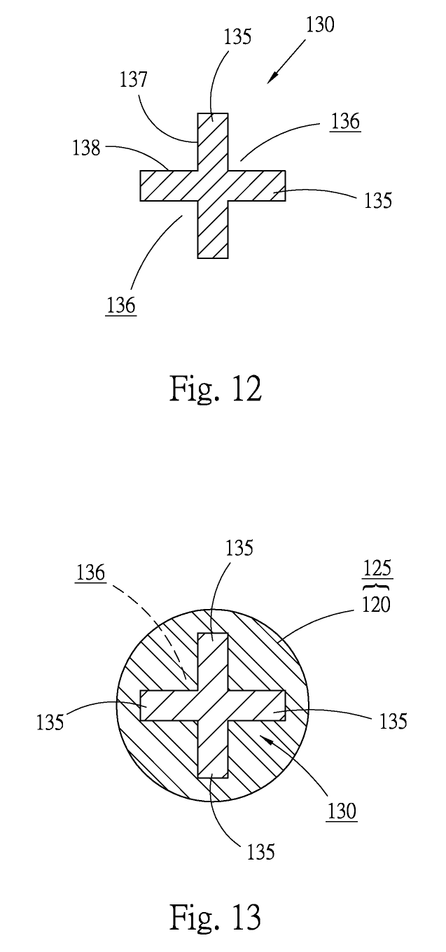

FIGS. 11 and 12 show a third embodiment of the insulated screwdriver 110 of the present invention, which also includes a main body 120, a shank body 130 and a driving member 140. The third embodiment is different from the first embodiment in that the shank body 130 has four rib sections 135 and thus the cross-section of the shank body 130 is cross-shaped as shown in FIG. 13.

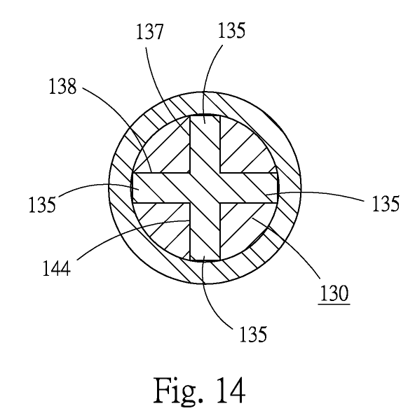

Referring to FIG. 14, the bottom end of the driving member 140 is formed with a cross-shaped socket 144 in which the top end of the shank body 130 can be inserted. The top end of the stem section 125 of the main body 120 encloses the circumference of the driving member 140 with the driving end 142 exposed to outer side as shown in FIG. 11.

Referring to FIG. 13, each two adjacent rib sections 135 of the shank body 130 define therebetween a recessed space 136. The material of the main body 120 is inlaid and engaged in the spaces 136 and the adjacent wall faces 137, 138 of the shank body 130 provide greater stopping force for the main body 120. Therefore, the main body 120 is connected with the shank body 130 by greater connection strength.

In the insulated screwdriver of the present invention, the connection strength between the shank body and the main body, which are made of different materials, is enhanced, while the weight of the insulated screwdriver is reduced.

It should be noted that the shank body of the present invention can alternatively have at least two rib sections and a substantially L-shaped cross-section is obtained and a recessed space is defined between the two rib sections. This can also achieve the object of the present invention.

The above embodiments are only used to illustrate the present invention, not intended to limit the scope thereof. Many modifications of the above embodiments can be made without departing from the spirit of the present invention.

What is claimed is:

1. An anti-loose and anti-detachment insulated screwdriver comprising:
a main body made of insulation material, the main body having a handle section and a stem section upward extending from a top end of the handle section;
a shank body made of metal material, the shank body being disposed and enclosed in the main body, a bottom end of the shank body being disposed in the handle section;
a driving member having a top end as a driving end; a bottom end of the driving member being connected with a top end of the shank body; a top end of the stem section of the main body enclosing a circumference of the driving member with the driving end exposed to outer side of the main body; and
the shank body in cross-section has at least two rib sections, each two adjacent rib sections defining therebetween a recessed space; a material of the main body being inlaid and engaged in the space of the shank body.

2. The insulated screwdriver as claimed in claim 1, wherein the shank body has three rib sections and has a Y-shaped cross-section.

3. The insulated screwdriver as claimed in claim 1, wherein the shank body has four rib sections and has a cross-shaped cross-section.

4. The insulated screwdriver as claimed in claim 1, wherein the shank body has three rib sections and has a T-shaped cross-section.

5. The insulated screwdriver as claimed in claim 1, wherein the bottom end of the driving member is formed with a socket in which the top end of the shank body is inserted to connect the driving member with the shank body.

6. The insulated screwdriver as claimed in claim 2, wherein the bottom end of the driving member is formed with a socket in which the top end of the shank body is inserted to connect the driving member with the shank body, the socket is Y-shaped.

7. The insulated screwdriver as claimed in claim 3, wherein the bottom end of the driving member is formed with a socket in which the top end of the shank body is inserted to connect the driving member with the shank body, the socket is cross-shaped.

8. The insulated screwdriver as claimed in claim 4, wherein the bottom end of the driving member is formed with a socket in which the top end of the shank body is inserted to connect the driving member with the shank body, the socket is T-shaped.

9. The insulated screwdriver as claimed in claim 1, wherein the bottom end of the shank body is positioned in an upper portion of the handle section.

10. The insulated screwdriver as claimed in claim 5, wherein the bottom end of the shank body is positioned in an upper portion of the handle section.

11. The insulated screwdriver as claimed in claim 1, wherein the driving member has an outer circumference with a polygonal configuration.

12. The insulated screwdriver as claimed in claim 10, wherein the driving member has an outer circumference with a polygonal configuration.

13. The insulated screwdriver as claimed in claim 1, wherein the driving end of the driving member is a polygonal insertion hole.

14. The insulated screwdriver as claimed in claim 2, wherein the driving end of the driving member is a polygonal insertion hole.

15. The insulated screwdriver as claimed in claim 3, wherein the driving end of the driving member is a polygonal insertion hole.

16. The insulated screwdriver as claimed in claim 4, wherein the driving end of the driving member is a polygonal insertion hole.

17. The insulated screwdriver as claimed in claim 5, wherein the driving end of the driving member is a polygonal insertion hole.

18. The insulated screwdriver as claimed in claim 9, wherein the driving end of the driving member is a polygonal insertion hole.

19. The insulated screwdriver as claimed in claim 10, wherein the driving end of the driving member is a polygonal insertion hole.

20. The insulated screwdriver as claimed in claim 12, wherein the driving end of the driving member is a polygonal insertion hole.
